(19) United States
(12) Patent Application Publication
(10) Pub. No.: US 2007/0095885 A1
(43) Pub. Date: May 3, 2007

(54) Pilfer-proof cash register

(76) Inventor: Duyong Liang, Whitby (CA)

Correspondence Address: DAVID W. WONG, 46 WILLOWBROOK ROAD, THORNHILL, ON, L3T 4W9, CA

(21) Appl. No.: 11/262,410

(22) Filed: Oct. 31, 2005

(51) Int. Cl. G07G 1/00

(52) U.S. Cl. 235/7 R

(57) ABSTRACT

A cash register is provided with a pilfer prevention construction. Openings are formed in both the cash tray and the bottom panel of the sliding drawer as well as the bottom panel of the cash register. The opening of the sliding drawer is covered with a transfer door panel hingedly mounted at its front edge to the bottom panel of the drawer. A spring-biassed latch maintains the transfer door panel in a closed position when the drawer extends outside the cash register. A control means is provided which is operative to release the latch so that the transfer door panel will swung open downwards through the opening of the bottom of the cash register to dispense money from cash tray into a safety deposit box located below the cash register. The transfer door panel will be automatically closed whenever the sliding drawer moves outwards.

### BACKGROUND OF THE INVENTION

1. Field of the Invention

This invention relates to cash registers and more particularly relates to a cash register construction having means for preventing pilfering of cash by the operator.

2. Background Art

A common problem for a store owner is the pilfering of cash by the untrustworthy employee operating the cash register. This is particularly prevalent in small size general stores in which the owner is unable to operate the cash register all the time and only a few employees would have to be employed in order to minimize the overhead expenses. For example, in a convenient general store or gas station, only one employee runs the store as well as operates the cash register. In such working condition, a dishonest employee could easily and unscrupulously steal a portion of the money from the sales by either entering only a much smaller amount of each sale into the cash register or not at all. Normally, a cash register serves only as a temporary storage of cash. It is not intended to store a large amount of money, and money in the cash register drawer must be removed and transfer to other safe storage such as a safe or safety deposit box for subsequent tallying and depositing to the bank. Only sufficient amount of money remains in the cash register for normal transaction in sale, and it would also reduce loss in case of robbery particularly during night shift. It is during the transfer of the money to the safe storage that the amount of money equal to the difference between the actual cash received from sales and the false amount of cash register entries is stolen by the employee. In this manner, the amount of money stolen is unknown since the amount of money in the safe deposit would agree with the records in the cash register. It has been estimated that loss of revenue from such prevalent pilfering and stealing by a dishonest employee may often amount to thousands or tens of thousands of dollars in this way. Such loss of revenue is particularly detrimental to a small general store owner. Video devices employed for monitoring the cash register can not detect the stealing since the actual stealing act is carried out away from the cash register. Common cash registers have security constructions for preventing the register itself from being stolen in robbery or preventing unauthorized operation thereof but they do not have any provision from preventing pilfering of cash by the operator.

### SUMMARY OF THE INVENTION

The above problem is obviated in the present invention by eliminating the necessity of having physically removing money from the cash register and transferring it to the safe storage locating away from the cash register. Money is removed and transfer to the safe storage directly without requiring the employee to remove and transfer the money physically from the cash register thus eliminating the opportunity for a dishonest employee to steal any money. Any attempt to remove money from the cash register apart from making change to the customer would be readily caught by the video monitoring system of the cash register.

Furthermore, the direct transfer of money to the safe storage would also drastically reduce the loss in case of robbery.

It is a principal object of the present invention to provide a cash register having a unique construction for reducing or preventing cash from being pilfered by the operator.

It is another object of the present invention to provide a cash register which automatically transfers money from the cash tray to a safe storage.

It is another object of the present invention to provide a cash register having an effective pilfering prevention means which is simple in structure.

### BRIEF DESCRIPTION OF THE DRAWINGS

FIG. 1 is a perspective top and side elevation view of the cash register according to the present invention.

FIG. 2 is a perspective bottom elevation view of the cash register showing a cash discharge opening formed in its bottom panel.

FIG. 3 is a perspective top elevation view of the cash tray of the cash register according to the present invention showing a release opening formed in a designated cash slot therein.

FIG. 4 is a perspective bottom elevation view of the cash tray thereof.

FIG. 5 is a perspective bottom elevation view of the cash register with the bottom panel removed showing the provision of a hinge-mounted covering door located at a transfer opening formed in the bottom panel of the sliding drawer.

FIG. 6 is a perspective bottom elevation view of the cash register of FIG. 5 with the covering door unlatched in the opened position.

FIG. 7 is a perspective bottom elevation view of the bottom panel of the cash register showing the covering door swung open through the discharge opening of the bottom panel.

FIG. 8 is an enlarged isolated rear elevation view showing the latching construction of the covering door.

FIG. 9 is a partially sectional side elevation showing the placement of the cash register on a counter top having a safe deposit box located the counter top for receiving the money discharged from the cash register.

FIG. 10 is a sectional side elevation view of the enclosure showing the sliding drawer positioned completely within the enclosure and at which the latch may be operated to open the transfer door panel.

FIG. 11 is a sectional side elevation view of FIG. 10 with the transfer door panel unlatched and swung open downwards when the sliding drawer lies completely within the enclosure of the cash register.

FIG. 12 is a sectional side elevation view of the enclosure showing the transfer door panel being automatically closed by abutting the wheel when the sliding drawer moves outwards.

FIG. 13 is a sectional side elevation view of FIG. 12 showing the complete closing of the transfer door panel by the wheel such that its rear edge is again engaged with latch when the sliding drawer moves further outwards.

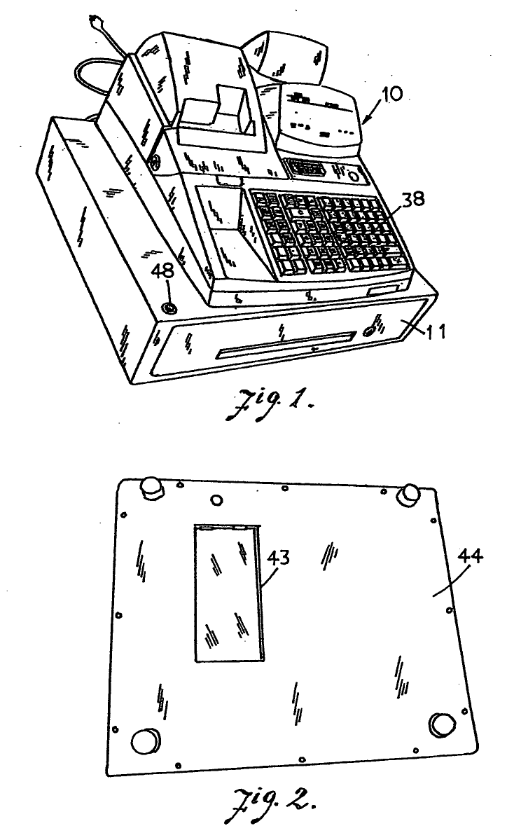

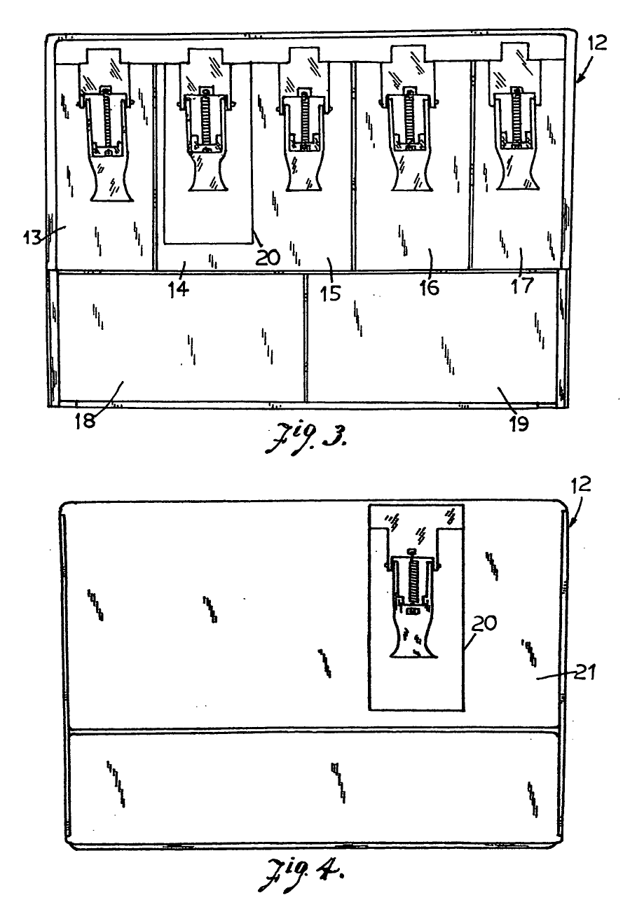

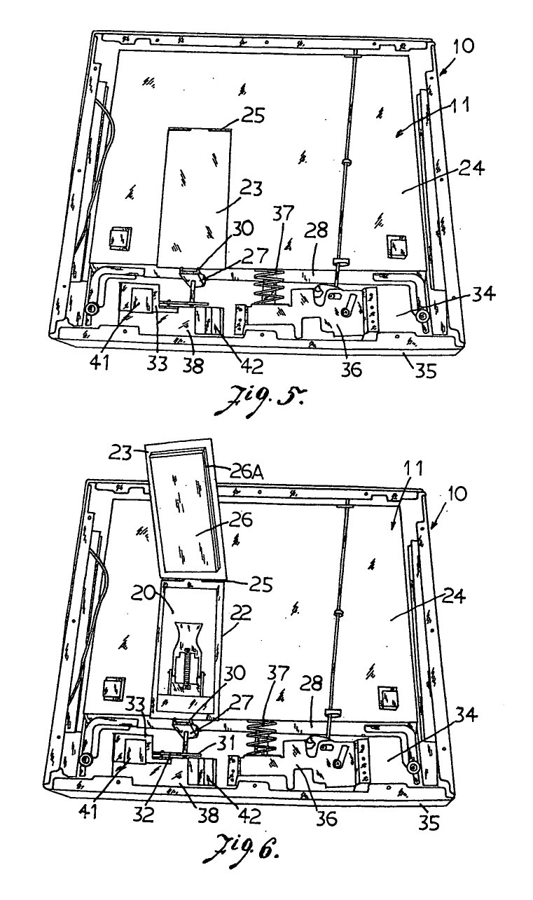

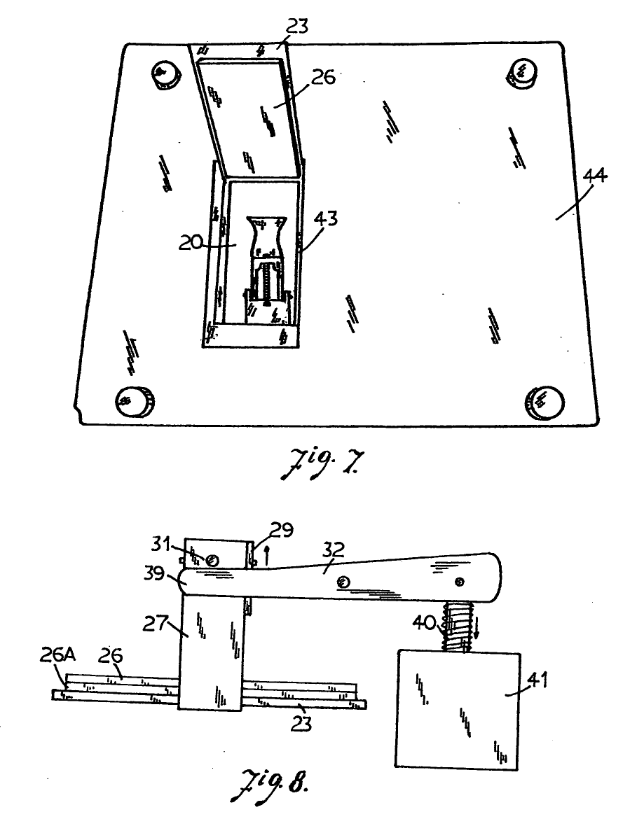

### DETAILED DESCRIPTION OF THE PREFERRED EMBODIMENTS

With reference to the drawings in which same reference numerals designate corresponding parts in the different views, a cash register 10 has a sliding drawer 11 and a removable cash tray 12 in a convention manner. The cash tray 12 is located in the sliding drawer 11, and which has divided compartments 13, 14, 15, 16, 17, 18 and 19 for holding bills and coins of various different denominations. According to the present invention, a rectangular release opening 20 is formed in the bottom panel 21 of a selected compartment of the cash tray 14. The rectangular release opening 20 is larger than the size of the paper money. A rectangular transfer opening 22 is formed in the bottom panel 24 of the sliding drawer 11. The transfer opening 22 is larger than the size of the release opening 20 of the cash tray 12 and located directly below the release opening 20 of the cash tray 12 when the latter is completely located inside the cash register. A rectangular transfer door panel 23 is located over the transfer opening 22. The transfer door panel 23 is slightly larger than the size of the transfer opening 22 with its front edge hingedly mounted to the bottom panel 24 of the sliding drawer 11 by a hinge 25 and its rear edge extends slightly beyond the rear edge of the bottom panel of the sliding drawer 11. A rectangular panel member 26 is made of the same material of the bottom panel of the cash tray 12 and having dimensions equal to the release opening 20 and it is affixed on the top surface of the transfer door panel 23. The rectangular panel member 26 may be provided by the rectangular portion removed from the bottom panel of the cash tray 12 to form the release opening such that when the transfer door 23 is in the closed position covering over the transfer opening 22, the rectangular panel member 26 will snugly locate within the release opening 20 of the cash tray 12 so that when viewed from top of the cash tray 12 the bottom panel 21 of the cash tray 12 will appear intact without any portion therein having been removed from its bottom panel 21. A spacer layer 26A such as a foam sponge may be provided between the transfer door 23 and the rectangular panel member 26 in order to ensure the rectangular panel member 26 will firmly and snugly locate within the rectangular release opening 20 of the cash tray 12.

A latch 27 is pivotally mounted at the rear panel 28 of the sliding drawer 11 by a supporting bracket 29. The latch 27 has a latching hook 30 facing the rear edge of the transfer door 23. The latch 27 is spring-biassed such that the latching hook 30 is normally engaged with the rear edge of the transfer door 23 to hold the latter in the closed position. The latch 27 has a horizontal arm 31 extending rearwards such that the latching hook 30 may be operated to disengage from the rear edge of the transfer door 23 by pivoting the horizontal arm 31 upwards against the biassing spring force.

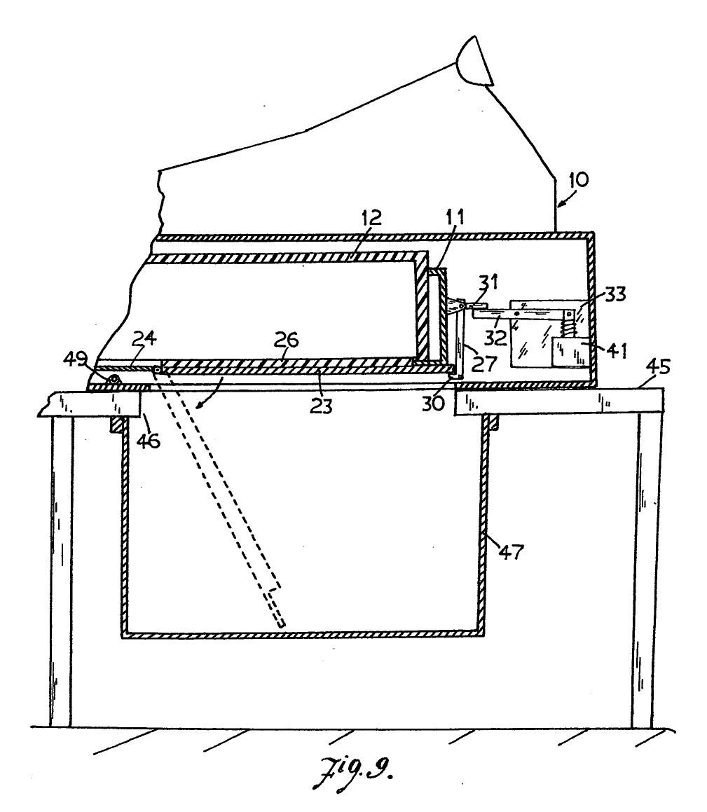

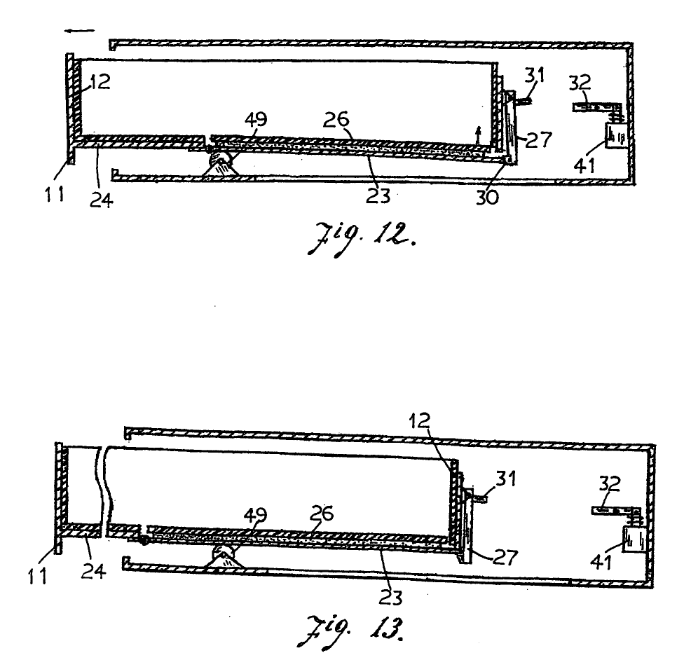

A rocker arm 32 is pivotally mounted on a support bracket 33 which is fixedly mounted within the rear compartment 34 located between the sliding drawer 11 and the rear panel 35 of the enclosure of the cash register 10. The rear compartment 34 houses the control mechanism 36 for operating the sliding drawer 11. The control mechanism 36 will retain the sliding drawer 11 in the pushed-in position to locate within the cash register normally, and it will push the sliding drawer 11 outwards with a compression spring 37 when an electronic control (not shown) is operated by entering the sale through the control keyboard 38 in a conventional manner for exposing the cash tray 12 in order that money may be deposited into the cash tray or may be retrieved therefrom to provide change to the customer. A free end 39 of the rocker arm 32 abuts the lower surface of the horizontal arm 31 of the latch 27. The other end of the rocker arm 32 is coupled to an extensible shaft 40 of an electrically operative spring-biassed solenoid 41 which may be also mounted to the support bracket 33. The solenoid 41 may be operated to pivot the rocker arm 32 to turn the horizontal arm 31 upwards so as to release the engagement of the latching hook 30 from the rear edge of the transfer door 23. The electrical power for operating the solenoid 41 may be provided through a step-down transformer 42 mounted to the support bracket 33. As best shown in the enlarged isolated view of FIG. 8 the rocker arm 32 is positioned perpendicular to the horizontal arm 31. Alternatively, the rocker arm 32 may be positioned in parallel and aligned with the horizontal arm 31 as shown in FIGS. 9 through 13.

As best shown in FIGS. 7 and 9, a large rectangular discharge opening 43 is formed at the bottom panel 44 of the cash register 10 and located directly below the transfer door 23 when the sliding drawer 11 is located completely within the cash register 10.

The cash register 10 of the present invention can be placed on a counter top 45 having a large rectangular dispensing opening 46 formed therein with the transfer opening 22 aligned with the large rectangular dispensing opening 46 of the counter top 45. An open top cash receiving safety deposit box 47 is mounted under the counter top 45 directly below the dispensing opening 46. The safety deposit box 47 is provided with a safe locking door in the conventional manner for accessing the money therefrom.

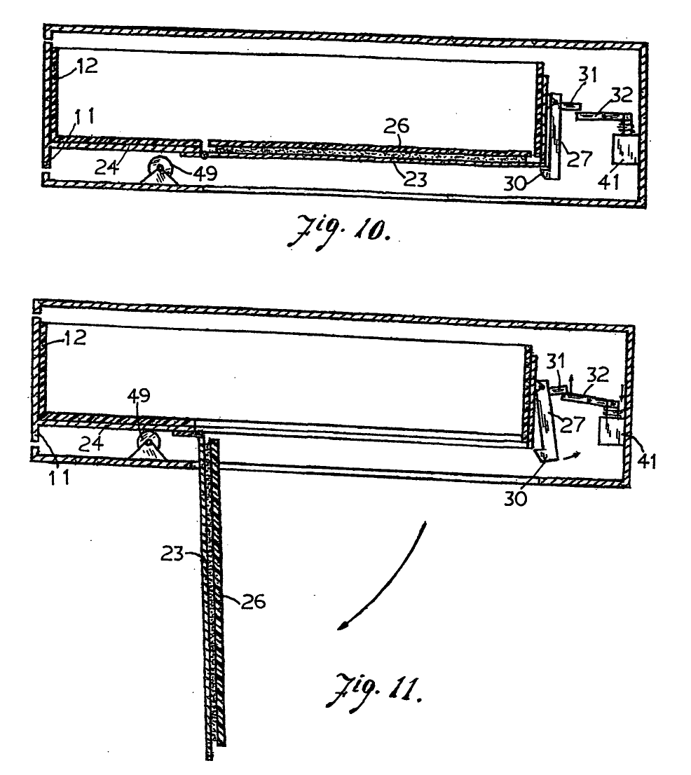

As shown in FIG. 10, normally the transfer door 23 is maintained closed with its rear edge engaged with the latching hook 30. When the operator makes a sale entry, the sliding drawer 11 with the cash tray 12 located therein will slide outwards of the register to allow the operator to place the money into the drawer and to provide change to the customer. The money may be placed in different compartments 13 through 19, while the bills of large denominations may be placed in the designated compartment 14. When the designated compartment 14 is almost full, the operator, after the sliding drawer 11 has been pushed back completely into the enclosure of the cash register 10, would depress a control button 48 located on the enclosure to actuate the solenoid 41 for disengaging the latch such that the transfer door 23 would swing open downwardly by gravity relative to the hinge 25 to release the money from the designated compartment 14 into the safe deposit box 47. The operator may also perform this operation to empty the money in the designated compartment 14 into the safe deposit box 47 and leaving just sufficient money in the other compartments for making change so as to reduce the amount of money in the cash register 10 in the night shift in which time there is higher potential of robbery occurring. The cash register operator is instructed to place all paper money as well as the coins in the designated compartment 14 at the completion of a work shift and from time to time, and to operated the control button 48 so as to transfer all money in the designated compartment 14 to the safety deposit box 47 leaving the cash tray 12 completely empty.

A rotary wheel 49 is mounted on the bottom panel 44 of the cash register 10. The opened transfer door 23 will abut this rotary wheel 49 when the sliding drawer 11 slides outwards to expose the cash tray 12 for depositing money therein and to provide change to the customer. The rotary wheel 49 will cause the transfer door 23 to swing upwards with the outward sliding movement of the sliding drawer 12 until it is again completely latched in place by the latching hook 30. Thus, whenever the sliding drawer 11 is opened, the transfer door 23 will be closed automatically and tightly to the bottom panel of the cash tray 12 to provide an integral appearance of the cash tray bottom panel when viewed from top.

The cash register of the present invention alleviates the necessity for the cash register operator to remove and transfer money from the cash register to another location remote from the cash register. Thus, it eliminates the opportunity as described above that the operator can pilfer any money.

While the present invention has been shown and described in the preferred embodiments thereof, it will be apparent that various modifications can be made therein without departing from the spirit of the essential attributes thereof, it is desired therefore that only such limitations be placed thereon as are imposed by the following appended claims.

What is claimed is:

1. A pilfering-proof cash register comprising:
a sliding drawer operative for sliding in and out of said cash register,
a cash tray removably located within said sliding drawer, said cash tray having a designated compartment for retaining cash of large denominations,
a release opening formed at a bottom panel of said designated compartment of said cash tray,
a transfer opening formed at a bottom panel of said sliding drawer, said transfer opening being aligned with said release opening when said cash tray is placed within said sliding drawer,
a transfer door panel hingedly mounted on said bottom panel of said sliding drawer and covering over said transfer opening by a hinge member provided between said bottom panel of said sliding drawer and a front edge of said transfer opening,
a latch mounted on said sliding drawer and operative for retaining said transfer door panel in a closed position closing over said transfer opening,
a discharge opening formed in a bottom panel of said cash register, said discharge opening being located directly below said transfer door panel when said sliding drawer is located within said cash register.

2. A cash register according to claim 1 wherein said release opening and transfer opening are larger in size than bills of large denominations and said discharge opening is larger in size than said transfer door panel.

3. A cash register according to claim 2 including a rectangular panel member mounted on a top surface of said transfer door panel, said rectangular panel member being made of same material of said cash tray and having a size same as said release opening.

4. A cash register according to claim 2 wherein said latch is pivotally mounted on a rear panel of said sliding drawer with a mounting bracket, a spring mounted on said mounting bracket for providing a biasing spring force to said latch for retaining said transfer door panel in said closed position.

5. A cash register according to claim 4 wherein said transfer door panel has a rear edge portion extending beyond said rear panel of said sliding drawer, and said latch has a hook shaped portion engageable with said rear edge portion of said transfer door panel for retaining said transfer door panel in said closed position.

6. A cash register according to claim 5 including a horizontal arm extending rearward from said latch and operative for pivoting said latch to disengage said hook shaped portion of said latch from said rear edge portion of said transfer door panel.

7. A cash register according to claim 6 including a solenoid having a retractable shaft coupled to said horizontal arm of said latch and operative for pivoting said horizontal arm.

8. A cash register according to claim 7 including a pivotable rocker arm having one end connected to said retractable shaft of said solenoid and another end located below and abutting said horizontal arm of said latch.

9. A cash register according to claim 8 including a switch mounted on said cash register and operative for activating said solenoid for pivoting said horizontal arm to disengage said hook shaped portion of said latch from said rear edge of said transfer door panel.

10. A cash register according to claim 9 including a rotary wheel mounted on said bottom panel of said cash register, said rotary wheel abutting said transfer door slidingly when said sliding drawer slides outwards of said cash register to maintain said transfer door closed.
